(19) United States
(12) Patent Application Publication
(10) Pub. No.: US 2025/0167693 A1
(43) Pub. Date: May 22, 2025

(54) INVERTER MOUNTING STRUCTURE

(71) Applicant: TOYOTA JIDOSHA KABUSHIKI KAISHA, Toyota-shi (JP)

(72) Inventors: Tetsumasa KINDAICHI, Nagoya-shi (JP); Yoko Ishiguro, Toyota-shi (JP)

(73) Assignee: TOYOTA JIDOSHA KABUSHIKI KAISHA, Toyota-shi (JP)

(21) Appl. No.: 18/777,796

(22) Filed: Jul. 19, 2024

(30) Foreign Application Priority Data
Nov. 22, 2023 (JP) 2023-198072

(51) Int. Cl. H02M 7/00; B60R 16/03

(52) U.S. Cl. CPC H02M 7/003; B60R 16/03

(57) ABSTRACT

An inverter mounting structure includes: an inverter mounted on a vehicle and disposed under a console box; a high voltage portion provided in either an upper right portion of the inverter or an upper left portion of the inverter; a top plate covering an upper surface of the inverter; a first side plate located adjacent to the high voltage portion in a vehicle width direction; and a second side plate located at an opposite side of the inverter from the first side plate. The first side plate includes a first region that faces the high voltage portion in the vehicle width direction, and a second region that does not face the high voltage portion in the vehicle width direction. The first region is located farther away from a side surface of the inverter in the vehicle width direction than the second region.

### CROSS-REFERENCE TO RELATED APPLICATION

This application claims priority to Japanese Patent Application No. 2023-198072 filed on Nov. 22, 2023, incorporated herein by reference in its entirety.

### BACKGROUND

### 1. Technical Field

The present specification discloses inverter mounting structures for mounting an inverter on a vehicle.

### 2. Description of Related Art

In recent years, electrified vehicles (e.g., battery electric vehicles, hybrid electric vehicles, and fuel cell electric vehicles) have been widely distributed. Electrified vehicles are equipped with an inverter that converts electric power from direct current to alternating current or from alternating current to direct current.

Japanese Unexamined Patent Application Publication No. 2021-191664 (JP 2021-191664 A) discloses a technique in which an inverter is mounted in a rear part of a vehicle. In JP 2021-191664 A, brackets are attached to both right and left sides of the inverter, and the inverter is fixed to a floor panel via the brackets.

### SUMMARY

An inverter typically includes a high voltage portion in which high voltage components such as a capacitor are disposed. Such a high voltage portion needs to be protected so as not to be damaged even in the event of a vehicle collision. The inverter is sometimes disposed under a console box. If an obstacle collides with the side of a vehicle with the inverter disposed under the console box, the high voltage portion may be damaged by a peripheral component such as a recliner shaft of a front seat. The technique of JP 2021-191664 has room for improvement in protection of such a high voltage portion.

The present specification discloses an inverter mounting structure that can more appropriately protect an inverter disposed under a console box.

An inverter mounting structure disclosed in the present specification includes:
an inverter mounted on a vehicle and disposed under a console box;
a high voltage portion provided in either an upper right portion of the inverter or an upper left portion of the inverter;
a top plate covering an upper surface of the inverter;
a first side plate located adjacent to the high voltage portion in a vehicle width direction; and
a second side plate located at an opposite side of the inverter from the first side plate.
   The first side plate includes a first region that faces the high voltage portion in the vehicle width direction, and a second region that does not face the high voltage portion in the vehicle width direction.
   The first region is located farther away from a side surface of the inverter in the vehicle width direction than the second region.

With this configuration, if a peripheral component such as a recliner shaft collides with the first side plate, the second region collides with a non-high voltage portion before the first region collides with the high voltage portion. This inhibits further movement of the peripheral component and thus inhibits further deformation or displacement of the first region. As a result, an impact is less likely to be applied to the high voltage portion via the first region, so that the high voltage portion is appropriately protected.

In this case, the inverter mounting structure may further include:
a tunnel extending in a vehicle front-rear direction under the inverter; and
a connecting bracket connecting the inverter to the tunnel.
   Panel materials of the first side plate, the second side plate, and the top plate may have a higher rigidity than a panel material of the connecting bracket.

With this configuration, in the event of a side impact collision, the connecting bracket is deformed so as to absorb deformation of the tunnel. The inverter is therefore less likely to be tilted, so that the peripheral component such as the recliner shaft is less likely to collide with the top plate. As a result, the high voltage portion is appropriately protected.

The top plate may include joining margins provided by bending both right and left end portions of the top plate downward, the joining margins being placed against the first side plate and the second side plate in the vehicle width direction.

Each of the first side plate and the second side plate may include a joining margin provided by bending an upper end portion of each of the first side plate and the second side plate in the vehicle width direction, the joining margin being placed against the top plate in a up-down direction.
The top plate and the first side plate, and the top plate and the second side plate, may both be joined together on upper and lateral sides.

This configuration can further improve the rigidity of a cover unit composed of the top plate, the first side plate, and the second side plate. Matchbox deformation of the cover unit can thus be effectively reduced, so that the high voltage portion can be more appropriately protected.

A connector may be provided on a rear end face of the inverter.

The inverter may be mounted in a front up attitude.

With this configuration, liquid is less likely to enter the inside of the inverter through the connector.

With the technique disclosed in the present specification, the high voltage portion of the inverter can be more appropriately protected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an arrangement of inverters;

FIG. 2 is a perspective view of an inverter;

FIG. 3 is a cross-sectional view of an inverter; and

FIG. 4 is a schematic diagram illustrating a state of an inverter when a right-side collision occurs.

### DETAILED DESCRIPTION OF EMBODIMENTS

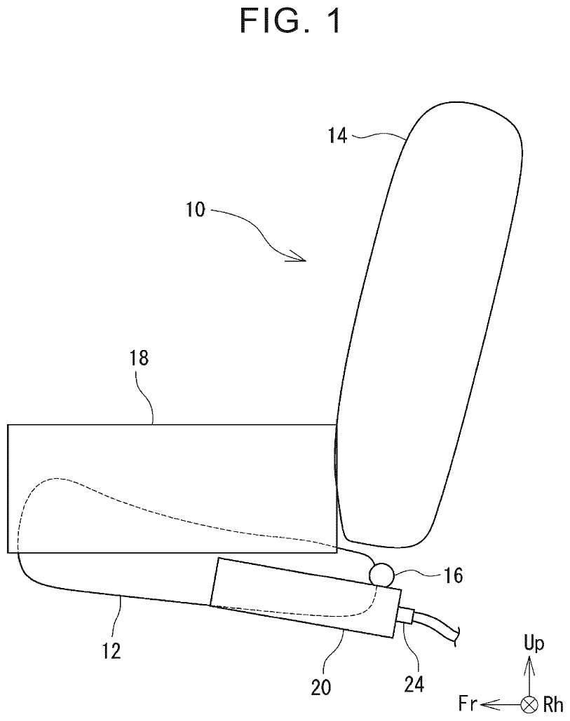

Hereinafter, a mounting structure of the inverter 20 will be described with reference to the drawings. FIG. 1 is a schematic diagram showing the arrangement of an inverter 20. In the drawings, Fr,Up,Rh indicate the front, upper, and right sides of the vehicles, respectively. In FIG. 1, the cover unit 29 and the connecting bracket 50 described later are not shown.

At a front portion of the vehicle, two front seat seats 10 are arranged at intervals in the vehicle width direction. Each front seat 10 includes a seat cushion 12 that supports the buttocks of the occupant, and a seat back 14 that supports the back of the occupant. The seat back 14 can be reclined around a recliner shaft 16 provided near the lower end thereof.

A console box 18 is disposed between the two seat cushions 12. The console box 18 is a box-shaped member capable of storing various items. In the present example, the console box 18 functions as a refrigerator having a cooling function. The occupant can store, for example, a PET bottle beverage or the like in the console box 18 (that is, a refrigerator). The top surface of the console box 18 also functions as an armrest for an occupant seated in the front seat 10.

The inverter 20 is disposed below the console box 18. The inverter 20 converts electric power of a battery (not shown) mounted on the vehicle from direct current to alternating current, and outputs the converted electric power to an electronic device.

A connector 24 to which a power cable is detachably attached is provided at a rear end of the inverter 20. The inverter 20 is fixed in such a front up attitude that the connector 24 faces obliquely downward. As described above, by directing the connector 24 obliquely downward, the liquid spilled on the interior floor surface of the vehicle is less likely to enter the inside of the inverter 20 through the connector 24.

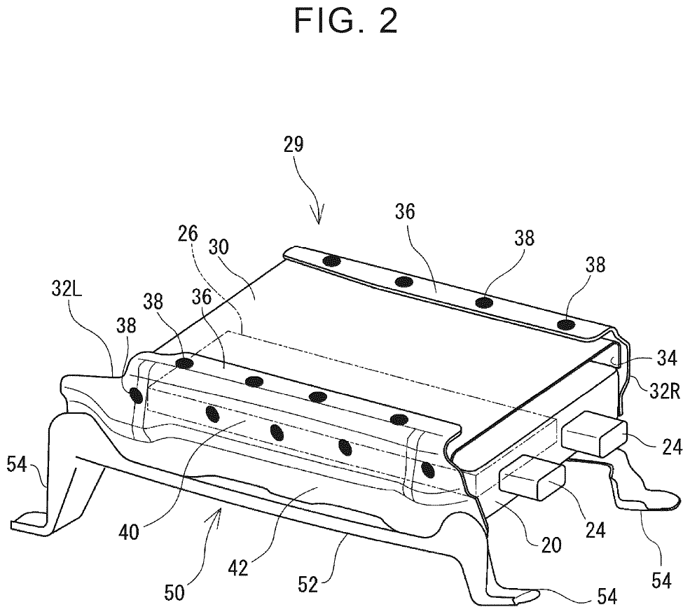

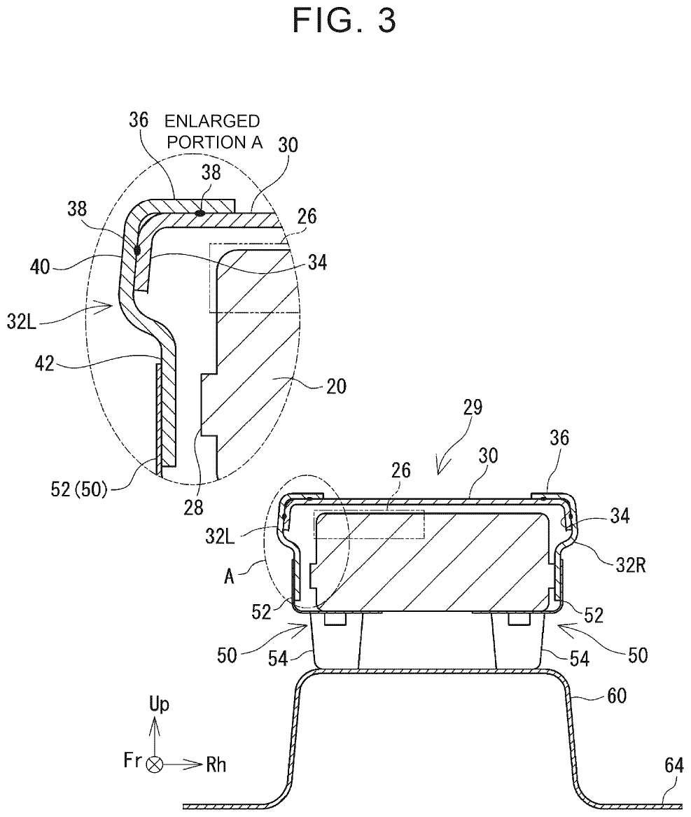

The inverter 20 is fixed to the tunnel 60 of the vehicle via the connecting bracket 50. In addition, the upper surface and the side surface of the inverter 20 are protected by the cover unit 29. Hereinafter, this will be described with reference to FIGS. 2 and 3. FIG. 2 is a perspective view of the inverter 20. FIG. 3 is a cross-sectional view of the inverter 20. In FIG. 2 and FIG. 3, in order to facilitate understanding, some shapes are illustrated in a simplified manner, and some dimensional ratios are made different from actual objects.

The inverter 20 has a flat rectangular shape. A high voltage component such as a capacitor is disposed in an upper left portion of the inverter 20 (a region surrounded by a two-dot chain line in FIGS. 2 and 3). Hereinafter, the region in which the high voltage component is disposed is referred to as a “high voltage portion 26”. The high voltage portion 26 is required to be appropriately protected even in the event of a vehicle collision without being damaged.

Therefore, in the present example, the cover unit 29 is provided to protect the high voltage portion 26. The cover unit 29 includes a top plate 30, a first side plate 32L, and a second side plate 32R. In the following description, when the first side plate 32L and the second side plate 32R are not distinguished from each other, they are simply referred to as “side plates 32”.

The top plate 30 is a panel member that covers the upper surface of the inverter 20. There is a slight gap between the upper surface of the inverter 20 and the top plate 30. Providing such a clearance reduces the possibility of an impact being transmitted to the high voltage portion 26 even when a strong impact is applied to the top plate 30. The top plate 30 has joining margins 34 formed by bending its right and left end portions downward. The joining margins 34 are placed against the side plate 32 in the vehicle width direction and bonded thereto. Note that the black circles in FIG. 2 and FIG. 3 indicate the junction 38 between the top plate 30 and the side plate 32.

The first side plate 32L is a panel member disposed on the left side of the inverter 20. As described above, the high voltage portion 26 is provided on the left side of the inverter 20. Therefore, the first side plate 32L adjoins the high voltage portion 26 in the vehicle width direction.

The first side plate 32L has a joining margin 36 formed by bending its upper end portion in the vehicle width direction. The joining margin 36 is placed against the top plate 30 in the up-down direction. Therefore, the top plate 30 and the first side plate 32L are joined to each other on two sides, namely on upper and lateral sides. This improves the stiffness of the joining parts of the top plate 30 and the first side plate 32L. As a result, deformation of the cover unit 29 in the event of a vehicle collision can be effectively reduced.

The body portion of the first side plate 32L (that is, a portion other than the joining margin 36) is roughly divided into a first region 40 and a second region 42. The first region 40 is a region of the upper half of the first side plate 32L, and is a region opposed to the high voltage portion 26 in the vehicle width direction. The second region 42 is a region of the lower half of the first side plate 32L, is vertically shifted with respect to the high voltage portion 26, and is a region not opposed to the high voltage portion 26. As shown in FIG. 3, a protrusion 28 protruding outward in the vehicle width direction is formed in a portion of the side surface of the inverter 20 facing the second region 42. The protrusion 28 is a high-rigidity portion formed by casting or the like. As shown in FIG. 3, a gap of a certain size exists between the first region 40 and the side surface of the inverter 20. Providing such a clearance reduces the possibility that an impact applied to the first region 40 may be transmitted to the high voltage portion 26.

The first region 40 is further away from the side surface of the inverter 20 in the vehicle width direction than the second region 42. Therefore, when the inverter 20 moves in the leftward direction (that is, a direction approaching the first side plate 32L), the second region 42 contacts the side surface of the inverter 20, more specifically, the protrusion 28, before the first region 40. Since the second region 42 comes into contact with the protrusion 28, further movement of the inverter 20 to the left is inhibited. This effectively reduces the possibility of the first region 40 coming into contact with the high voltage portion 26 and the possibility of an impact being transmitted to the high voltage portion 26.

The second side plate 32R is a panel material disposed at the right side of the inverter 20, that is, at the opposite side of the inverter 20 from the first side plate 32L. Similarly to the first side plate 32L, the second side plate 32R also has a joining margin 36 formed by bending its upper end portion in the vehicle width direction. The second side plate 32R and the top plate 30 are joined together at the joining margin 36 and the joining margin 34. Therefore, the top plate 30 and the second side plate 32R are also joined to each other on two sides, namely on upper and lateral sides. Thus, it is possible to effectively reduce deformation of the cover unit 29 at the time of a vehicle collision.

A connecting bracket 50 is attached to the inverter 20. The connecting bracket 50 is a bracket that couples the inverter 20 to the tunnel 60. Here, the tunnel 60 is a portion where the floor panel 64 is raised in a tunnel shape, and is a convex portion extending in the vehicle front-rear direction.

A total of two connecting brackets 50 are provided, one on each of the right and left sides. The connecting brackets 50 are roughly divided into a base portion 52 and a leg portion 54. The base portion 52 is disposed on the lower side of the inverter 20, and is screwed and fastened to the bottom surface of the inverter 20. An end portion of the base portion 52 in the vehicle width direction stands upward. The standing portion is placed against the side plate 32 in the vehicle width direction, and is screwed and fastened to the side plate 32. The leg portion 54 is a portion extending downward from the base portion 52. The distal end of the leg portion 54 is threadedly fastened to the tunnel 60.

Here, the cover unit 29 is made of a material having higher rigidity than that of the connecting bracket 50. Specifically, the panel members constituting the top plate 30 and the side plate 32 are made of a material having a higher rigidity than the panel members constituting the connecting bracket 50. Further, as is apparent from FIG. 3, the plate thickness of the panel material constituting the top plate 30 and the side plate 32 is larger than the plate thickness of the panel material constituting the connecting bracket 50.

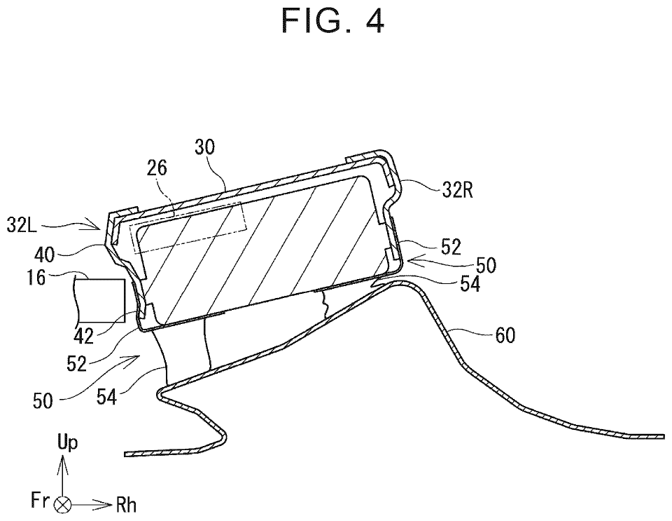

Next, the reason for adopting the above-described mounting structure will be described. FIG. 4 is a schematic diagram illustrating a state of the inverter 20 when a right-side collision in which an obstacle collides with the vehicle from the right side occurs. As shown in FIG. 4, when the right side protrusion occurs, the tunnel 60 is largely deformed so that the whole thereof falls to the left side. Then, the upper surface of the tunnel 60 is inclined downward to the left.

As the tunnel 60 deforms, the inverter 20 is displaced to the left. Here, a recliner shaft 16 of the front seat 10 is present on the vehicle width direction outer side of the inverter 20. When the recliner shaft 16 collides with the high voltage portion 26 on the upper left side of the inverter 20, the high voltage portion 26 may be damaged. In the present embodiment, the first side plate 32L and the top plate 30 are disposed around the high voltage portion 26.

As described above, the top plate 30 and the side plate 32 are made of a panel material having high rigidity. A predetermined gap is formed between the top plate 30 and the side plate 32 and the high voltage portion 26. Therefore, even if the recliner shaft 16 collides with the first side plate 32L or the top plate 30, the impact is not transmitted to the high voltage portion 26. As a result, damage to the high voltage portion 26 can be effectively reduced.

As described above, the first side plate 32L has the first region 40 facing the high voltage portion 26 and the second region 42 not facing the high voltage portion 26, and the first region 40 is farther from the side surface of the inverter 20 than the second region 42. Therefore, when the recliner shaft 16 collides with the first side plate 32L from the left side and the first side plate 32L is displaced or deformed toward the inverter 20, the second region 42 contacts the side surface of the inverter 20 before the first region 40. When the second region 42 contacts the side surface of the inverter 20, further movement of the recliner shaft 16 to the right, and thus further displacement or deformation of the first side plate 32L, is inhibited. This effectively reduces the possibility of the first region 40 coming into contact with the high voltage portion 26 and the possibility of an impact being transmitted to the high voltage portion 26.

Further, in the present embodiment, the top plate 30, the first side plate 32L, and the second side plate 32R are all made of a high-rigidity panel material, and are joined together in two directions, namely in the up-down direction and the vehicle width direction. With such a configuration, the rigidity of the cover unit 29 is increased, and matchbox deformation of the cover unit can be effectively reduced. Matchbox deformation is a deformation such that the match box collapses obliquely. When such a match box deformation occurs in the cover unit 29, the gap between the first side plate 32L and the high voltage portion 26 is narrowed, and an impact is easily transmitted to the high voltage portion 26. In the present example, since matchbox deformation of the cover unit 29 is effectively reduced, the high voltage portion 26 can be protected more appropriately.

Further, as described above, the connecting bracket 50 has a lower rigidity than the cover unit 29 and is relatively easily deformed. As a result, when a right-side protrusion as shown in FIG. 3 occurs, the connecting bracket 50 fastened to the tunnel 60 easily deforms so as to absorb the deformation of the tunnel 60. Specifically, the leg portion 54 of the left connecting bracket 50 is greatly extended, but the leg portion 54 of the right connecting bracket 50 is compressed and collapsed in the up-down direction. As a result, although the upper surface of the tunnel 60 is greatly inclined, the inclination of the inverter 20 located above the leg portion 54 is suppressed to be small. This effectively reduces the possibility of the recliner shaft 16 colliding with the top plate 30 of the inverter 20.

That is, in a case where the rigidity of the connecting bracket 50 is high and the connecting bracket 50 is not deformed, the inverter 20 and the cover unit 29 are greatly inclined upward in the rightward direction in the same manner as the upper surface of the tunnel 60 due to the deformation of the tunnel 60. In this case, the top plate 30 faces the recliner shaft 16, and the recliner shaft 16 easily collides with the top plate 30. When the recliner shaft 16 collides with the top plate 30, an impact may be transmitted to the high voltage portion 26 via the top plate 30. On the other hand, when the connecting bracket 50 is easily deformed as in the present example, the inverter 20 and the cover unit 29 are less likely to be tilted, so that collision of the recliner shaft 16 with the top plate 30 can be effectively reduced. As a result, the high voltage portion 26 can be appropriately protected.

The connecting bracket 50 can be easily deformed independently of the tunnel 60, and has a rigidity that does not easily break even when subjected to an impact. Since the connecting bracket 50 does not break, the inverter 20 is less likely to be completely separated from the tunnel 60, which effectively reduces the possibility of the inverter 20 moving to an unexpected location.

As is apparent from the above description, according to the present embodiment, the high voltage portion 26 of the inverter 20 can be appropriately protected. Note that the above description is merely an example, and other configurations may be changed as long as the configuration described in claim 1 is provided. For example, the shapes of the first side plate 32L and the connecting brackets 50 may be changed as appropriate.

What is claimed is:

1. An inverter mounting structure, comprising:
an inverter mounted on a vehicle and disposed under a console box;
a high voltage portion provided in either an upper right portion of the inverter or an upper left portion of the inverter;
a top plate covering an upper surface of the inverter;
a first side plate located adjacent to the high voltage portion in a vehicle width direction; and
a second side plate located at an opposite side of the inverter from the first side plate, wherein
the first side plate includes a first region that faces the high voltage portion in the vehicle width direction, and a second region that does not face the high voltage portion in the vehicle width direction, and
the first region is located farther away from a side surface of the inverter in the vehicle width direction than the second region.

2. The inverter mounting structure according to according to claim 1, further comprising:
a tunnel extending in a vehicle front-rear direction under the inverter; and
a connecting bracket connecting the inverter to the tunnel, wherein panel materials of the first side plate, the second side plate, and the top plate have a higher rigidity than a panel material of the connecting bracket.

3. The inverter mounting structure according to claim 1, wherein
the top plate includes joining margins provided by bending both right and left end portions of the top plate downward, the joining margins being placed against the first side plate and the second side plate in the vehicle width direction,
each of the first side plate and the second side plate includes a joining margin provided by bending an upper end portion of each of the first side plate and the second side plate in the vehicle width direction, the joining margin being placed against the top plate in a up-down direction, and
the top plate and the first side plate, and the top plate and the second side plate, are both joined together on upper and lateral sides.

4. The inverter mounting structure according to according to claim 1, wherein
a connector is provided on a rear end face of the inverter, and
the inverter is mounted in a front up attitude.
